(19) United States
(12) Patent Application Publication
(10) Pub. No.: US 2026/0094232 A1
(43) Pub. Date: Apr. 2, 2026

(54) SYSTEMS AND METHODS FOR KEY-VALUE (KV) CACHE PRUNING

(71) Applicant: Salesforce, Inc., San Francisco, CA (US)

(72) Inventor: Yuhui Xu, Singapore (SG)

(21) Appl. No.: 19/040,001

(22) Filed: Jan. 29, 2025

Related U.S. Application Data
(60) Provisional application No. 63/701,836, filed on Oct. 1, 2024.

(51) Int. Cl. G06T 1/60; G06T 1/20

(52) U.S. Cl. CPC G06T 1/60; G06T 1/20

(57) ABSTRACT

Embodiments described herein provide a key-value (KV) cache pruning framework to improve hardware efficiency while maintaining computational accuracy of large language models (LLMS). Specifically, the channel dimension D of a key cache (or value cache) may be pruned by dynamically identifying unimportant channels based on data dependent criterion and abstracting away identified redundancies in each head's key cache (or value cache). The framework is orthogonal to other KV cache compression schemes (e.g., KV cache eviction, quantization) and can complement (without incurring loss) these other schemes. Therefore, with such improved memory optimization in KV caching, neural network technology in LLMs is improved.

### CROSS REFERENCE(S)

The instant application is a nonprovisional of and claim priority under 35 U.S.C. 119 to U.S. provisional application No. 63/701,836, filed Oct. 1, 2024, which is hereby expressly incorporated by reference herein in its entirety.

### TECHNICAL FIELD

The embodiments relate generally to machine learning systems for large language models (LLMs), and more specifically to key-value (KV) cache pruning in LLMs to reduce memory consumption associated with lengthy sequences.

### BACKGROUND

AI agents, commonly known as AI agents or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI agents can assist with product recommendations, order tracking, and personalized shopping experiences. In information technology (IT) support, these agents can guide users through troubleshooting steps, helping them resolve software and hardware issues. Specifically, for network hazards, AI agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task.

However, generative language models such as large language models (LLMs) incur significant expenses, which escalate with increasing model size and sequence length. Operating LLMs often require significant hardware resources, such as memory space, processing capacity, and/or the like.

### BRIEF DESCRIPTION OF THE DRAWINGS

FIG. 1 illustrates an application of an LLM based AI agent, according to embodiments of the present disclosure.

FIG. 2 illustrates an example architecture of a generative neural network such as Generated Pre-trained Transformer (GPT) or other Transformer-based LLM that uses precomputed and cached system prompt variables, according to at least one embodiment.

FIG. 3 is a simplified diagram illustrating a KV cache pruning framework according to some embodiments.

FIGS. 4A-4B illustrate different implementations of the KV cache pruning framework described in FIG. 3, according to some embodiments.

FIG. 5 is a simplified diagram illustrating a computing device implementing the KV cache pruning framework described in FIG. 3, according to some embodiments.

FIG. 6 is a simplified diagram illustrating a neural network structure, according to some embodiments.

FIG. 7 is a simplified block diagram of a networked system suitable for implementing the KV cache pruning framework described in FIG. 3 and other embodiments described herein.

FIG. 8 is an example logic flow diagram illustrating a method of managing cache usage on a graphic processing unit (GPU) for a Transformer-based neural network model, according to some embodiments.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

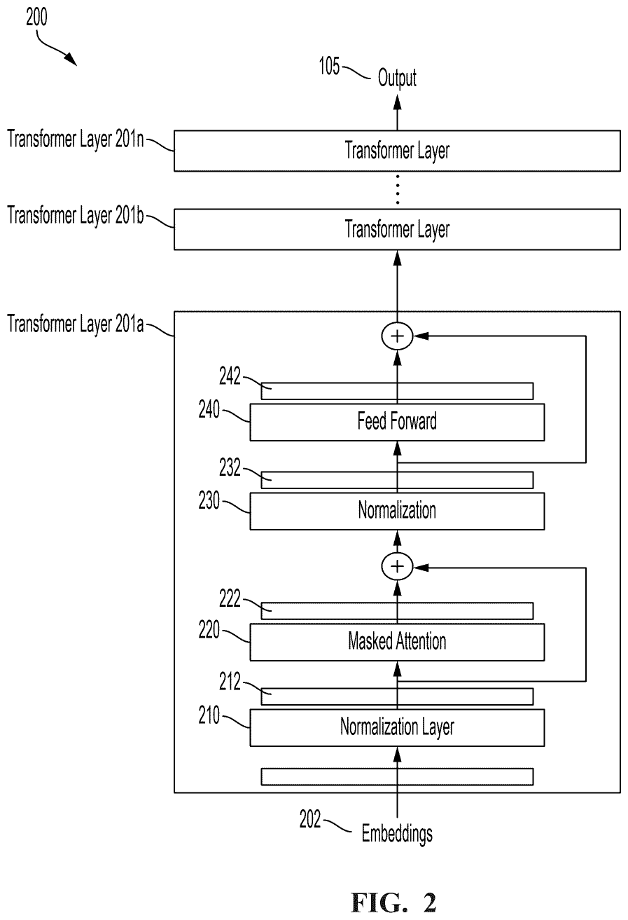

As used herein, the term “Transformer” may refer to an architecture of a deep learning model designed to process sequential data, such as text, using a mechanism called self-attention. The Transformer architecture handles an entire input sequence of tokens (such as words, letters, symbols, etc.) in parallel, and often generate an output sequence of tokens sequentially. The Transformer architecture may comprise a stack of Transformer layers, each of which contains a self-attention module to weigh the importance of each token relative to other tokens in the sequence and a feed-forward module to further transform the data. Additional details of how a Transformer neural network model processes input data to generate an output is provided in relation to FIG. 2, along with other associated figures.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “generative artificial intelligence (AI)” may refer to an AI system that outputs new content that does not pr-exist in the input to such AI system. The new content may include text, images, music, or code. An LLM is an example generative AI model that generate tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

### Overview

Large language models (LLMs), due to its growing size, often require significant hardware resources to implement and manage. In a Transformer-based LLM or other Transformer based neural network models, input data is converted to intermediate variables known as keys, values and/or queries, which is often stored in a cache in the graphical processing unit (GPU) memory. The GPU memory thus, in addition to model parameters, takes the burden to store keys, values, and queries, which scale linearly with both sequence length of the input and batch size of input data such as training data. The key-value (KV) cache helps to maintain context and to reduce the need for redundant computations. However, when sequence length and batch size increase, KV cache load also increases. An increase of KV cache load may cause slowdowns in GPU memory due to greater memory consumption associated with lengthy sequences. This results in a substantial memory burden when the LLM processes long sequences, such as in a summarization task, or a retrieval augmented generation task, when the input may comprise documents of a large number of tokens. Consequently, effective management of KV cache is essential for the practical deployment of LLMs.

In view of the need for hardware efficiency for LLMs, embodiments described herein provide a KV cache pruning mechanism to improve hardware efficiency while maintaining computational accuracy of neural network operations. For example, within a Transformer based neural network model, the number of KV cache parameters is the product of batch size B, sequence length S, number of layers L, number of heads N, channel size of each head D, i.e., K,V∈R^{B×S×L×N×D}, which need to be stored in the GPU memory during inference. To reduce memory and computational costs during inference, the dimensions across S, L, N, D may be reduced, e.g., by selectively removing certain portions of the KV cache memory using a greedy algorithm while maintaining a minimum negative impact on computational accuracy, e.g., referred to as the KV cache memory cost. The KV cache pruning may be performed during an inference instance by selecting the portion of the KV cache to prune in real-time. Alternatively, KV cache pruning may be performed based on observations of a large amount of training and/or testing data to determine a portion of less significance of the KV cache for pruning. In this way, with reduced cost and/or demand on GPU memory, computational and hardware efficiency of Transformer based neural networks can be improved.

For example, existing cache management methods may attempt to minimize the KV memory cost from dimension S or L, but have largely overlooked the channel dimension D. In the KV cache pruning framework presented herein, the channel dimension D is specifically targeted by dynamically identifying unimportant channels based on data dependent criterion and abstracting away identified redundancies in each head's key cache.

Embodiments of the KV cache pruning framework described herein provide a number of benefits. The KV cache optimization framework reduces the dimensionality of the cache channel, leading to linear saving in both memory and computational requirements. Notable, the framework greatly reduces key cache size with negligible performance loss. This is because the framework preserves the original architecture of the LLM by specifically targeting the channel dimensions. The framework is orthogonal to other KV cache compression schemes (e.g., KV cache eviction, quantization) and can complement (without incurring loss) these other schemes. Therefore, with such improved memory optimization in KV caching, hardware efficiency in neural network deployment technology is improved.

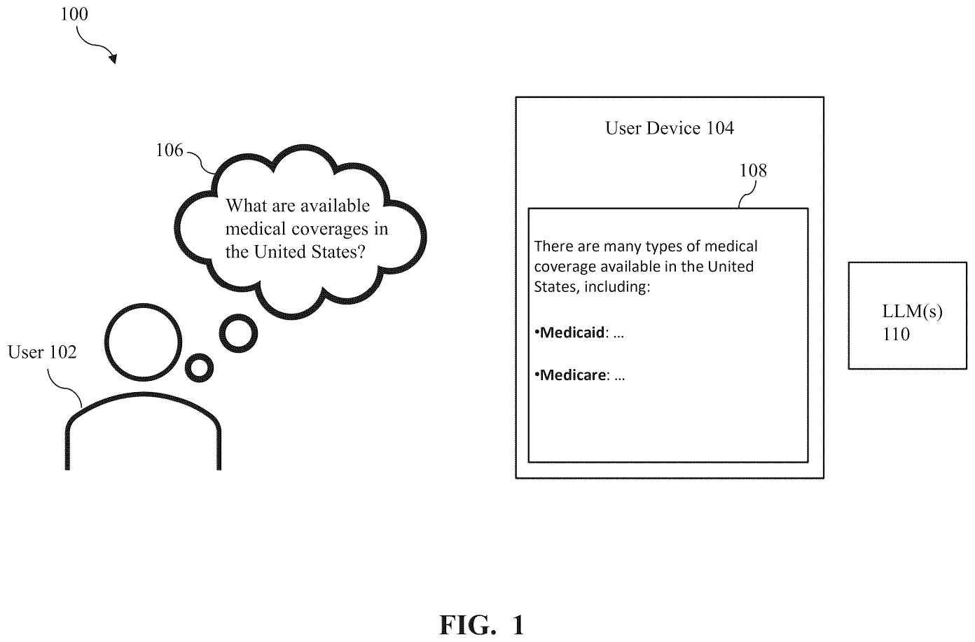

FIG. 1 shows an application 100 of an LLM based AI agent, according to embodiments of the present disclosure. A user 102 may utter or enter a query 106 in natural language. In response, a user device 104 may output/display an answer 108 on a display interface, such as a screen. In some embodiments, answer 108 is the output of an artificial intelligence (AI) agent, which is built on a bot server that is communicatively connected to user device 104. The AI agent may be based on, or include, an LLM. In some embodiments, the LLM receives query 106 through utterance of user 102, which may retrieve a corpus of documents, and generate an output based on the retrieved documents.

As an example, query 106 may include a question of “What are available medical coverages in the united states?” The AI agent may include the query 106 in a predefined format providing instruction to the LLM how to generate a response to query 106, referred to as a “prompt,” which may be fed to an LLM as input. The LLM 110 may in turn provide answer 108, e.g., a summary of the types of medical coverages in a predetermined format, e.g., a bullet-point format, such that one type of medical coverage is listed behind a bullet-point. In some aspects, for example, a citation of document(s) that mentioned the medical coverage is provided behind the respective bullet. The underlying LLM may be implemented at user device 104, or at a remote server which is accessible by the user device 104. The LLM may be trained with a large corpus of texts and/or documents to provide a user desirable response.

FIG. 2 illustrates an example architecture 200 of a generative neural network such as Generated Pre-trained Transformer (GPT) or other Transformer-based LLM (e.g., LLM 110) that uses precomputed and cached system prompt variables, according to at least one embodiment. The generative neural network may comprise a Transformer-based architecture comprising a number of Transformer layers 201a-201n. Each Transformer layer such as 201a may comprise a normalization layer 210, a masked attention layer 220, a normalization layer 230 and a feed forward layer 240.

Embeddings 202 are received (or generated) as input into the Transformer-based architecture 200. As an example, input text of the query 106 is broken up into tokens, and each token may be embedded into text and position embeddings 202. The embeddings 202 are then processed through each layer of each Transformer Layer 201n.

Normalization layer 210 may generate a normalized embedding 212 as an input sequence into the masked attention layer 220. The masked attention layer 220 may generate an attention weight vector 222 representing an importance or relevance of different parts of the input sequence of the normalized embedding 212. Within each transformer layer (e.g., 201a), the masked attention layer 220 may receive three input vectors (or matrices) that are computed from normalized embedding 212, referred to as a query vector (or matrix), a key vector (or matrix), and a value vector (or matrix), based on which an attention mechanism may calculate attention weights representing an importance or relevance of different parts of an input sequence (e.g., embeddings 202) when generating an answer 108.

A query vector (or matrix) may be computed as a current position or element for which an output is to be generated, e.g., the query vector is the element being considered during each step of the attention calculation. A key vector (or matrix) may be computed as positions or elements in an input sequence (e.g., embeddings 202) and may be used to compute the relevance between the query and the keys. Entries in a key vector may indicate information about different parts of the input sequence that the LLM(s) 110 may pay attention to when generating an answer 108 for a current user request 102. A value vector (or matrix) may be computed to contain information about the input sequence and serve as a source of information that LLM(s) 110 retrieves when attending to the query and keys. Values in the value vector may be combined with the attention weights to produce a final output for a query.

Masked attention layer 220 may compute relevance or attention scores between a query vector and each key vector (e.g., using dot product or scaled dot product between two vectors). Each attention score may measure how similar a query and a key are. These attention scores may be then normalized through a softmax function to produce attention weight vector 222 that represent how much focus should be placed on each value. In an embodiment, another normalization layer 230 may generate a normalized attention weight vector 232 from the attention weight vector 222. The attention weight vector 222 (or normalized attention weight vector 232) is fed into a feed forward layer 240 to generate a feed forward output 242.

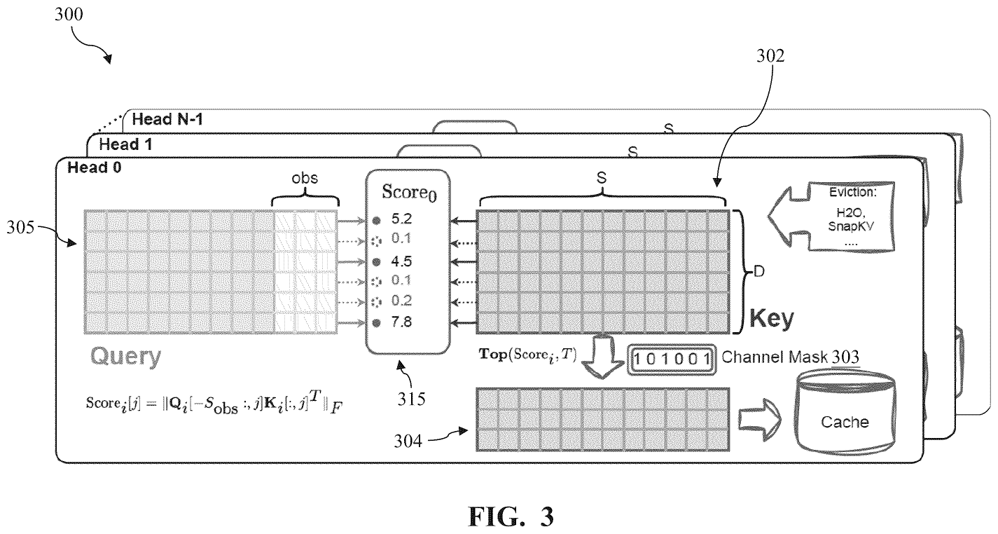

As sequence length and batch size increases, calculating the masked attention layer 220 requires increased computational resources. One way to increase computational efficiency is through key-value (KV) caching, where key and value matrices from previous steps are stored and reused during the generation of subsequent tokens, allowing for the reduction of redundant computations and speeding up inference time. However, KV caching takes up significant memory, giving rise to tradeoffs between memory against compute. Embodiments described in relation to FIGS. 3-8 below describes improvements to KV cache through a KV cache pruning framework. The framework exploits the compute advantages of a KV cache while reducing its associated memory consumption.

FIG. 3 is a simplified diagram illustrating a KV cache pruning framework 300 according to some embodiments. The framework 300 focuses on pruning the key cache of the KV cache. The framework 300 is developed based on discoveries that the magnitudes of the key cache are significantly unbalanced and they vary abruptly between channels (either very high or very low). This discovery suggests redundancies in the channel dimension D of the key cache, and that a small subset of singular values often captures most of the information in attention mechanisms. Further, it is discovered through singular value decomposition (SVD) that the attention matrix is inherently low-rank, and a low-rank matrix approximation can effectively capture the essential information in the key cache. As such, the framework 300 may approximate the key cache using low-dimensional vectors to prune the key cache channels based on a criterion score.

Considering a batch of requests to a LLM service (e.g., input query 106 through architecture 200), the total KV cache size can be computed as follows: 2×B×S×L×N×D. This calculates cache size for two matrices (one for keys and one for values), where L is the number of layers, N is the number of heads, and D is the channel dimension in each head. The KV cache size grows linearly as the batch size Band sequence length S increase.

The framework 300 prunes the key cache from the channel dimension D, which can be done orthogonal to (i.e., in addition to or concurrently to) pruning the KV cache in the other dimensions (e.g., sequence length S and/or the layer dimension L). For example, when paired with token eviction and KV cache quantization methods, the framework 300 achieves not only superior accuracy but also reduces KV cache memory costs by more than 20%. The framework 300 reduces the dimensionality of the cache channel D, leading to linear saving in both memory and computational requirements.

The framework 300 illustrates an attention layer L (e.g., masked attention layer 220) having N number of heads. For each head (e.g., Head 0), there is a query matrix storing queries 305 and a corresponding key matrix storing keys 302. Each head also includes a value matrix storing values (not shown). Briefly described, within each head, criterion scores 315 (also referred to as attention scores) are calculated for each channel of a query/key pair, and only the top T channels out of D channels are selected for retention. The top T channels indicate channels D with largest scores (e.g., greater than 4). The score reflects channels with the highest interaction magnitudes, thus retaining the most significant contributions to the attention mechanism. This criterion ensures that the selected channels preserve the primary information flow in the computation, thereby minimizing the loss of important information. In this query-driven pruning, the importance of each channel is ranked on a query-by-query basis, and only the channels with the largest scores are selected. Further, to reduce computation cost, only the last window of input sequence (obs) (e.g., last 3 tokens of a sequence S) may be used to calculate the score. This is because the last window of input sequence has highly similar attention allocation pattern with the actual generation.

Referring to FIG. 3 in further detail, the attention scores 315 are computed using the queries 305 and keys 302, and then the attention scores 315 are then applied to the values (not shown). The formula for the attention for head i is: Attention

$$( {Q}_{i} , {K}_{i} , {V}_{i} ) = softmax ( \frac{{Q}_{i} {K}_{i}^{T}}{\sqrt{D}} ) {V}_{i} ,$$

where (Qᵢ, Kᵢ, Vᵢ)∈ [symbol] ^{S×D}. When a channel of Kᵢ is pruned, the corresponding channel in Qᵢ will also be removed. An optimal subset of channels to prune is denoted by a selection matrix S∈{0,1}^{D×D} (e.g., channel mask 303), where S is a diagonal matrix with binary entries (1 for keeping a channel, 0 for pruning it). To better maintain the performance after pruning the channels, the Frobenius norm of the difference between the original and pruned attention weights is minimized by the formula

$${min}_{s} {‖ {Q}_{i} {K}_{i}^{T} - {Q}_{i} S {( {K}_{i} S )}^{T} ‖}_{F} .$$

Given a pruning ratio λ, it can further be expanded as:

$$\begin{matrix}{min}_{S} {‖ {Q}_{i} {K}_{i}^{T} - {Q}_{i} {SK}_{i}^{T} ‖}_{F} \\ subject to trace ( S ) = ⌊ ( 1 - λ ) D ⌋ \\ S = diag ( {s}_{1} , {s}_{2} , … , {s}_{D} ) where {s}_{j} ∈ \{ 0 , 1 \}\end{matrix}$$

For simplicity, a greedy algorithm is used to optimize S. To achieve the pruning goal, a criterion score 315 is defined for evaluating the importance of each channel. Top channels with the largest scores are greedily selected:

$${Score}_{i} [ j ] = {‖ {Q}_{i} [ : , j ] {{K}_{i} [ : , j ]}^{T} ‖}_{F} , {I}_{i} = {Top}_{T} ( {Score}_{i} , T ) .$$

The Scoreᵢ[j] measures the magnitude of the interaction between the query and key vectors for channel j in each head i. By selecting channels with the highest interaction magnitudes, the most significant contributions to the attention mechanism is retained. This criterion ensures that the selected channels preserve the primary information flow in the attention computation, thereby minimizing the loss of important information. In one embodiment, the calculated Scoreᵢ[j] (e.g., attention scores 315) is compared with a score threshold, and only channels with attention scores 315 above the score threshold is kept (e.g., above 4).

In the embodiment shown, only the last S_{obs} window is used to calculate the score: ∥Qᵢ[−S_{obs}:,j] Kᵢ [:,j]^{T}∥_{F}. This reduces computation cost, as the last window of input sequence recognizes highly similar attention pattern with generation. In an embodiment, the S_{obs} window is the last 3 channels of an input sequence.

As a result of implementing the framework 300, one or more rows of the key matrix (i.e., channels) are pruned via the selection matrix (e.g., channel mask 303) based on a score threshold, and the pruned keys 304 with reduced channel dimension D are stored into cache memory. In the depicted embodiment, the key matrix corresponds to keys 302 stored in cache memory before pruning, and the pruned key matrix corresponds to the pruned keys 304 stored in cache memory. Note that by removing and reducing channels in the key cache, the corresponding channels in the query matrix will also be removed.

The framework 300 is described as implementing query-driven pruning where channels are filtered out based on attention scores 315 indicating a degree of relevance between keys 302 and queries 305. However, in alternative embodiments, the channels may be pruned via magnitude-based pruning based on absolute magnitude values of keys 302 in each channel. In magnitude-based pruning, instead of calculating a score based on each query, the norm of the magnitude is used to measure the importance of different channels in the key cache:

$${M}_{n , d} = {‖ K [ n , : , d ] ‖}_{p}$$

Given pruning ratio λ, only the top channels T=└(1−λ)┘ D are kept. These channels corresponds to the most important channels among the D channels of each head. For example, I= [symbol] Top [symbol] _T (M, T) where ∥⋅∥ₚ is the lₚ norm of each channel, n∈[1, N] and d∈[1, D] are indicators of heads and channels in key cache, and I∈( [symbol] ⁺)^{N×T} stores the indicators of the top T values in tensor M per head. In one embodiment, the calculated norm of the magnitude M_{n,d} is compared with a score threshold, and only channels with magnitude M_{n,d} above the score threshold is kept (e.g., above 4). In an example study, a 30% pruning ratio can maintain accuracy, indicating that the key cache is redundant in the channel dimension D. However, increasing it to 40% results in significant performance degradation, especially for l₁ norm based pruning, indicating the need for a better pruning matrix to achieve higher pruning ratios effectively, such as the query-driven and query-specific pruning previously described. Although involving a more complicated pruning algorithm, the query-driven pruning can consistently achieve pruning ratios greater than 40% without performance degradation. Depending on various tradeoff considerations, the present disclosure contemplates pruning the channel dimension D of the key cache via either query-drive pruning or magnitude-based pruning.

The framework 300 is described as pruning key caches, but the present disclosure is not limited thereto. In further embodiments, value caches may also be pruned similar to the key caches, such as through query-driven pruning or magnitude-based pruning described above. The difference would be that the pruning would be performed on channels of the value matrix instead of channels of the key matrix. In one embodiment, the value cache are pruned instead of the key cache. In another embodiment, the value cache are pruned in addition to pruning the key cache, resulting in further memory usage reduction. Notably, comparing between key cache pruning versus value cache pruning, key cache pruning may be more aggressively pruned due to greater magnitude variations between channels in the key cache compared to magnitude variations between channels in the value cache (e.g., criterion scores 315 for key cache pruning is higher than criterion scores for value cache pruning). For query-driven value cache pruning, the criterion score for determining top channels T to retain may be based on a dot product between the attention scores and the value matrix, where

$$\begin{matrix}Score \text{?} ( {Q}_{i} , {K}_{i} , {V}_{i} ) [ j ] = ‖ softmax ( \frac{{Q}_{i} [ - {S}_{obs} : ] {K}_{i}^{T}}{\sqrt{D}} ) {V}_{i} [ : , j ] ‖ F \\ {I}_{i} = {Top}_{T} ( Score \text{?} , T )\end{matrix}$$

$$\text{?} \text{indicates text missing or illegible when filed}$$

The criterion Score_{v,i} indicate the importance of each channel in the head i of value cache.

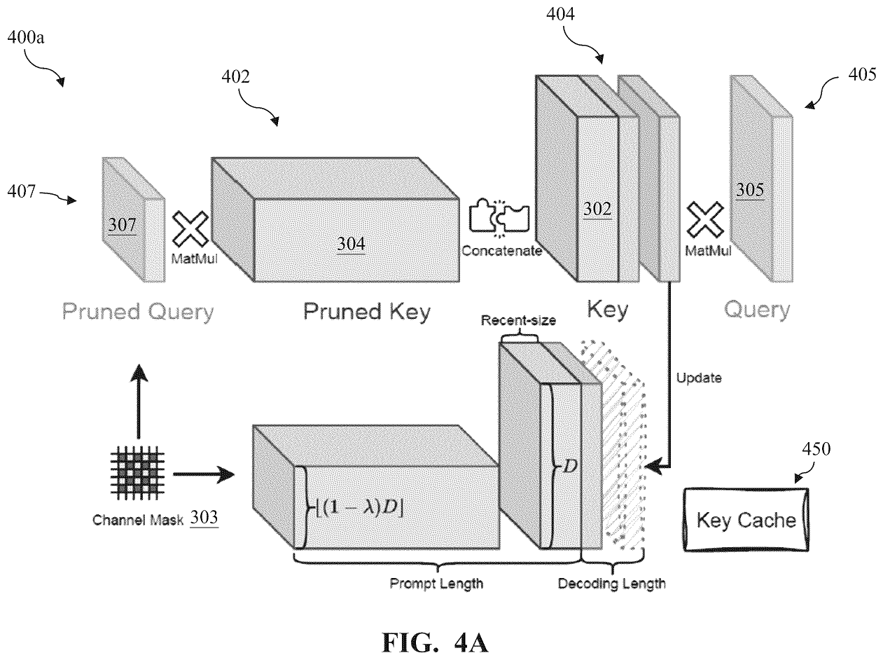

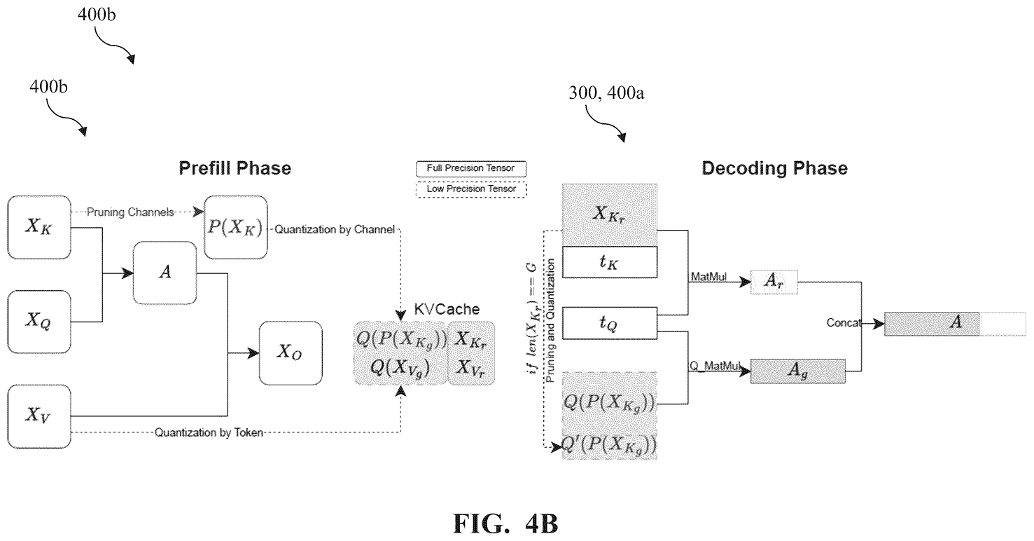

FIGS. 4A-4B illustrate different implementations of the KV cache pruning framework 300 described in FIG. 3, according to some embodiments. FIG. 4A illustrates an architecture 400a of how pruned keys 304 are stored in cache memory (e.g., key cache 450). During decoding, the most recent tokens and newly generated keys (e.g., new keys 404) are not pruned in order to capture all information for the most recent queries, values, and keys. In other words, only older processed tokens and generated keys (e.g., old keys 402) are pruned. For example, the KV cache pruning may be performed during an inference instance by selecting an older portion of the KV cache to prune in real-time. Alternatively, or additionally, KV cache pruning may be performed based on observations of a large amount of training and/or testing data to determine a portion of less significance of the KV cache for pruning. Consequently, the KV cache will store two distinct categories of keys: one subset consists of pruned keys 304 with a reduced channel size (e.g., with dimension (1−λ)D) while the other (e.g., original keys 302 with dimension D) retains keys at their original size. Additionally, a binary mask (e.g., channel mask 303) is stored to indicate which channels have been pruned. The memory overhead associated with this mask is negligible.

Still referring to FIG. 4A, a method of storing pruned keys 304 may include initially pruning the query 305 to form pruned query 307 using the channel mask 303. The pruned query 307 includes old queries 407 that correspond to the old keys 402, while the query 305 includes new queries 405 that correspond to the new keys 404. The pruned query 307 is then multiplied by the pruned key 304, while the new queries 405 (i.e., unpruned query) is multiplied to the new keys 404 (i.e., unpruned key). Subsequently, the two outputs are concatenated.

FIG. 4B illustrates an implementation 400b that integrates the channel pruning method described in framework 300 with other KV cache compression techniques. As described herein, the framework 300 is agnostic to existing KV cache compression methods. Thus, the framework 300 can advantageously combine with other KV pruning/compression techniques to further improve performance and memory reduction. In the implementation 400b, KV cache is pruned and quantized through a prefill phase 400b followed by a decoding phase. The decoding phase may be implemented according to architecture 400a and framework 300 as described herein. During the prefill phase, unimportant channels of X_{K} are first pruned before applying quantization by channel. In the decoding phase, each newly arrived key cache t_{K} is added to X_{K}_{ᵣ} Once X_{K}_{ᵣ} reaches G tokens, the residential length hypermeter, the data is pruned and quantized, then it is concatenated with the previously quantized [symbol] [symbol] Q(P(X [symbol] _{K} [symbol] _{g})). In this way, the framework 300 is integrated with KV cache quantization, further improving hardware efficiency.

Of note, framework 300 preserves the original architecture of the LLM (e.g., LLM 110) and specifically targets the channel dimension D within each head's key cache. As such, other techniques targeting other dimensions of the key cache can concurrently be applied. These may include KV cache eviction techniques to prune the sequence length S dimension, structured pruning techniques to remove unimportant layers in the layer dimension L, and/or other techniques to remove unimportant heads in the head dimension N.

### Computer and Network Environment

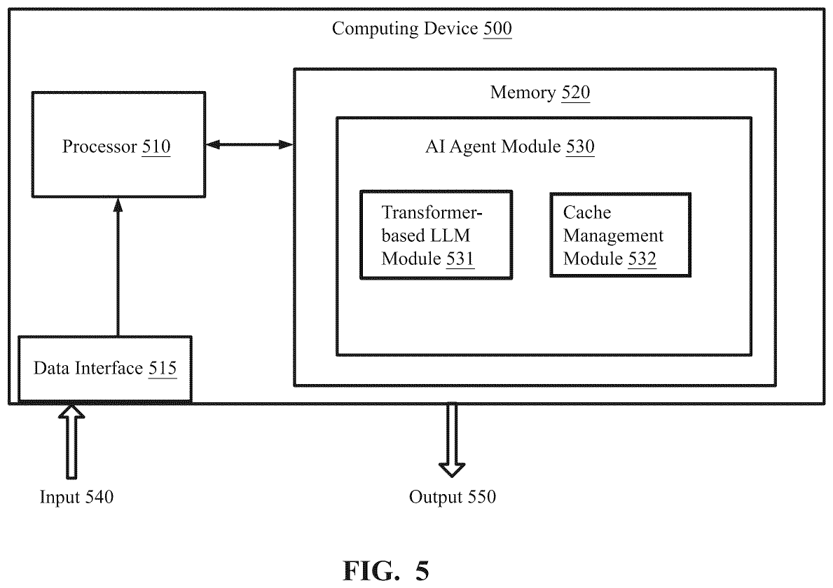

FIG. 5 is a simplified diagram illustrating a computing device 500 implementing the KV cache pruning framework 300 described in FIGS. 3 and 4A-4B, according to one embodiment described herein. As shown in FIG. 5, computing device 500 includes a processor 510 coupled to memory 520. Operation of computing device 500 is controlled by processor 510. And although computing device 500 is shown with only one processor 510, it is understood that processor 510 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 500. Computing device 500 may be implemented as a stand-alone subsystem, as a board added to a computing device, and/or as a virtual machine.

Memory 520 may be used to store software executed by computing device 500 and/or one or more data structures used during operation of computing device 500. Memory 520 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

In some embodiments, memory 520 may comprise cache memory with a GPU, CPU, and/or the like.

Processor 510 and/or memory 520 may be arranged in any suitable physical arrangement. In some embodiments, processor 510 and/or memory 520 may be implemented on a same board, in a same package (e.g., system-in-package), on a same chip (e.g., system-on-chip), and/or the like. In some embodiments, processor 510 and/or memory 520 may include distributed, virtualized, and/or containerized computing resources. Consistent with such embodiments, processor 510 and/or memory 520 may be located in one or more data centers and/or cloud computing facilities.

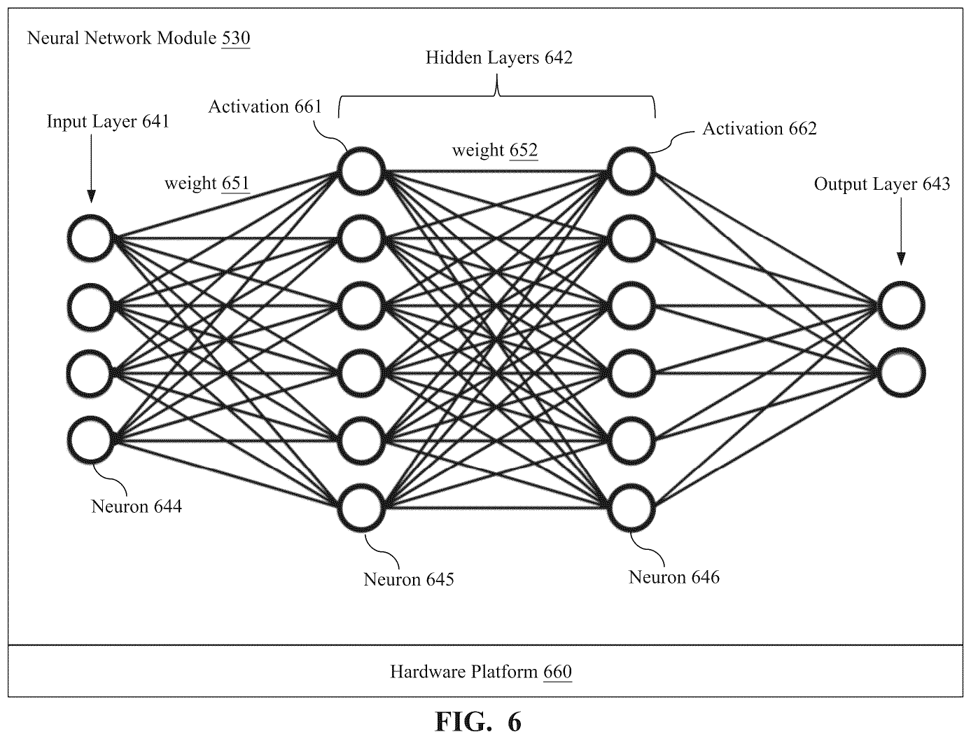

In another embodiment, processor 510 may comprise multiple microprocessors and/or memory 520 may comprise multiple registers and/or other memory elements such that processor 510 and/or memory 520 may be arranged in the form of a hardware-based neural network, as further described in FIG. 6.

In some examples, memory 520 may include non-transitory, tangible, machine readable media that includes executable code that when run by one or more processors (e.g., processor 510) may cause the one or more processors to perform the methods described in further detail herein. For example, as shown, memory 520 includes instructions for neural network module 530 that may be used to implement and/or emulate the systems and models, and/or to implement any of the methods described herein. Neural network module 530 may receive input 540 such as a user input (e.g., similar to 106 in FIG. 1) via the data interface 515 and generate an output 550 similar to 108 in FIG. 1. Neural network module 530 may convert the input 540 to output 550 through layers of computations, as further described in FIG. 6.

The data interface 515 may comprise a communication interface, a user interface (such as a voice input interface, a graphical user interface, and/or the like). For example, the computing device 500 may receive the input 540 (such as a training dataset) from a networked database via a communication interface. Or the computing device 500 may receive the input 540, such as embedding of a query from a user via the user interface.

In some embodiments, the neural network module 530 is configured to perform operations and calculations as described with respect to FIGS. 1-4. The neural network module 530 may further include submodules such as a KV cache module 531 for implementing various operations described herein (e.g., query-based and/or magnitude-based KV cache pruning.

Some examples of computing devices, such as computing device 500 may include non-transitory, tangible, machine readable media that include executable code that when run by one or more processors (e.g., processor 510) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 6 is a simplified diagram illustrating the neural network structure implementing the neural network module 530 described in FIG. 5, according to some embodiments. In some embodiments, the neural network module 530 and/or one or more of its submodules (e.g., KV cache module 531) may be implemented at least partially via an artificial neural network structure shown in FIG. 6. The neural network comprises a computing system that is built on a collection of connected units or nodes, referred to as neurons (e.g., 644, 645, 646). Neurons are often connected by edges, and an adjustable weight (e.g., 651, 652) is often associated with the edge. The neurons are often aggregated into layers such that different layers may perform different transformations on the respective input and output transformed input data onto the next layer.

For example, the neural network architecture may comprise an input layer 641, one or more hidden layers 642 and an output layer 643. Each layer may comprise a plurality of neurons, and neurons between layers are interconnected according to a specific topology of the neural network topology. The input layer 641 receives the input data (e.g., 540 in FIG. 5), such as input words embedded into numerical vectors. The number of nodes (neurons) in the input layer 641 may be determined by the dimensionality of the input data (e.g., the length and number of a vectors). Each node in the input layer represents a feature or attribute of the input.

The hidden layers 642 are intermediate layers between the input and output layers of a neural network. It is noted that two hidden layers 642 are shown in FIG. 6 for illustrative purpose only, and any number of hidden layers may be utilized in a neural network structure. Hidden layers 642 may extract and transform the input data through a series of weighted computations and activation functions.

For example, input words (e.g., from query 106) are embedded into vectors at the input layer 641 as embeddings 202. The embedding 202 may be inputs into the neural network module 530. Query, key, and value vectors (or matrices) are then derived from the embedded input words. The derived query, key, and values may then become the inputs into the KV cache module 531 for cache pruning. After cache pruning by the KV cache module 531, a resulting output 550 may be the pruned keys or values stored into memory cache. The resulting output 550 (e.g., pruned keys or values) may then be used as optimized key cache or value cache to implement an attention mechanism in the input layer 641 (e.g., an attention layer). The neural network module 530 and/or the associated KV cache module 531 may support multiple layers (e.g., input layer 641, hidden layers 642, and/or output layer 643) for cache memory optimization as part of the neural network transformation.

To perform the transformation, each neuron receives input signals, performs a weighted sum of the inputs according to weights assigned to each connection (e.g., 651, 652), and then applies an activation function (e.g., 661, 662, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 641 is transformed into rather different values indicative data characteristics corresponding to a task that the neural network structure has been designed to perform.

The output layer 643 is the final layer of the neural network structure. It produces the network's output or prediction based on the computations performed in the preceding layers (e.g., 641, 642). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the neural network module 530 and/or one or more of its submodules (e.g., KV cache module 531) may comprise the transformative neural network structure of layers of neurons, and weights and activation functions describing the non-linear transformation at each neuron. Such a neural network structure is often implemented on one or more hardware processors 610, such as a graphics processing unit (GPU). An example neural network may be a recurrent neural network, a convolutional neural network, and/or the like.

In one embodiment, neural network module 530 and/or one or more of its submodules (e.g., KV cache module 531) may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may processes the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The Q K, V matrices contain tunable weights of a Transformer-based language model that are updated during training. Then, the attention mechanism computes attention scores between all tokens in the input sequence using the Q K and V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each step using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached.

The generated sequence of tokens may jointly represent an output. For example, a Transformer-based LLM (such as LLM 110) may receive a natural language input (such as a question (e.g., query 106)) and generate a natural language output (such as an answer 108 to the question).

In one embodiment, the neural network module 530 and/or one or more of its submodules (e.g., KV cache module 531) may be implemented by hardware, software and/or a combination thereof. For example, neural network module 530 and/or one or more of its submodules (e.g., KV cache module 531) may comprise a specific neural network structure implemented and run on various hardware platforms 660, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 660 used to implement the neural network structure is specifically configured based on factors such as the complexity of the neural network, the scale of the tasks (e.g., training time, input data scale, size of training dataset, etc.), and the desired performance.

For example, to deploy the neural network module 530 and/or one or more of its submodules (e.g., KV cache module 531), the neural network module 530 and/or one or more of its submodules (e.g., KV cache module 531) may be optimized for deployment by converting it to a suitable format, such as ONNX or TensorRT, to improve performance and compatibility. Next, depending on the size and workload requirements for modules neural network module 530 and/or one or more of its submodules (e.g., KV cache module 531), hardware types may be chosen for deployment, e.g., processing capacity, GPU memory size, and/or the like. Frameworks and drivers for the chosen hardware 6660 frameworks and drivers may thus be installed, such as PyTorch, TensorFlow, or CUDA, to support the hardware platform 660. Then, weights and parameters of the neural network module 530 and/or one or more of its submodules (e.g., KV cache module 531) may be loaded to the hardware 660. For large-scale deployments (e.g., with billions of weights for example), distributed computing frameworks may be used to handle model partitioning across multiple devices, e.g., hardware processors such as GPUs may be distributed on multiple devices, each handling a portion of weights of the model and therefore would undertake a portion of computational workload. In some embodiments, the neural network module 530 and/or one or more of its submodules (e.g., KV cache module 531) may be deployed as a service, then they may be integrated with an API endpoint, using tools like Flask, FastAPI, or a cloud platform serverless services, and is accessible by a remote user via a network.

In another embodiment, some or all of layers 641, 642, 643 and/or neurons 642, 645, 646, and operations there between such as activations 661, 662, and/or the like, of the neural network module 530 and/or one or more of its submodules (e.g., KV cache module 531) may be realized via one or more ASICs. For example, each neuron 642, 645 and 646 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the neural network module 530 and/or one or more of its submodules (e.g., KV cache module 531) may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based neural network module 530 and/or one or more of its submodules (e.g., KV cache module 531) may be trained by iteratively updating the underlying parameters (e.g., weights 651, 652, etc., bias parameters and/or coefficients in the activation functions 661, 662 associated with neurons) of the neural network based on a loss. For example, during forward propagation, the training data such as input data 540 are fed into the neural network. The data flows through the network's layers 641, 642, with each layer performing computations based on its weights, biases, and activation functions until the output layer 643 produces the network's output 550. In some embodiments, output layer 643 produces an intermediate output on which the network's output 550 is based.

The output generated by the output layer 643 is compared to the expected output (e.g., a “ground-truth” such as the corresponding summary of an input training document) from the training data, to compute a loss function that measures the discrepancy between the predicted output and the expected output. For example, the loss function may be cross entropy, MMSE, and/or the like. Given the loss, the negative gradient of the loss function is computed with respect to each weight of each layer individually. Such negative gradient is computed one layer at a time, iteratively backward from the last layer 643 to the input layer 641 of the neural network. These gradients quantify the sensitivity of the network's output to changes in the parameters. The chain rule of calculus is applied to efficiently calculate these gradients by propagating the gradients backward from the output layer 643 to the input layer 641.

In one embodiment, the neural network based neural network module 530 and/or one or more of its submodules (e.g., KV cache module 531) may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning—in other words, backward propagation and forward propagation may occur for both “training” and “inference” stages of the neural network mode.

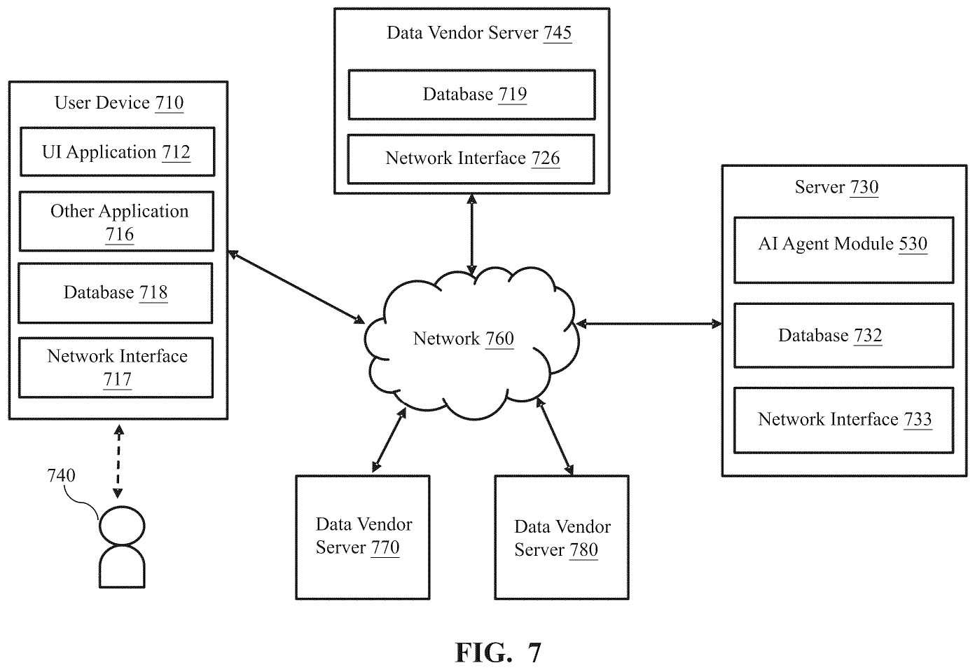

In some embodiments, neural network module 530 and/or one or more of its submodules (e.g., KV cache module 531) may be housed at a centralized server (e.g., computing device 500) or one or more distributed servers. For example, one or more of neural network module 530 and/or one or more of its submodules (e.g., KV cache module 531) may be housed at external server(s). The different modules may be communicatively coupled by building one or more connections through application programming interfaces (APIs) for each respective module. Additional network environment for the distributed servers hosting different modules and/or submodules may be discussed in FIG. 7.

During a backward pass, parameters of the neural network are updated backwardly from the last layer to the input layer (backpropagating) based on the computed negative gradient using an optimization algorithm to minimize the loss. The backpropagation from the last layer 643 to the input layer 641 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as generating a next word or sentence and utilizing the pruned key or value caches according to the neural network module 530.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. By utilizing the neural network module 530, the trained neural network improves neural network technology by reducing memory consumption.

FIG. 7 is a simplified block diagram of a networked system 700 suitable for implementing the KV cache pruning framework 300 described in FIG. 3 and other embodiments described herein. In one embodiment, system 700 includes the user device 710 which may be operated by user 740, data vendor servers 745, 770 and 780, server 730, and other forms of devices, servers, and/or software components that operate to perform various methodologies in accordance with the described embodiments. Exemplary devices and servers may include device, stand-alone, and enterprise-class servers which may be similar to the computing device 500 described in FIG. 5, operating an OS such as a MICROSOFT® OS, a UNIX® OS, a LINUX® OS, or other suitable device and/or server-based OS. It can be appreciated that the devices and/or servers illustrated in FIG. 7 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 710, data vendor servers 745, 770 and 780, and the server 730 may communicate with each other over a network 760. User device 710 may be utilized by a user 740 (e.g., a driver, a system admin, etc.) to access the various features available for user device 710, which may include processes and/or applications associated with the server 730 to receive an output data anomaly report.

User device 710, data vendor server 745, and the server 730 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 700, and/or accessible over network 760.

User device 710 may be implemented as a communication device that may utilize appropriate hardware and software configured for wired and/or wireless communication with data vendor server 745 and/or the server 730. For example, in one embodiment, user device 710 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 710 of FIG. 7 contains a user interface (UI) application 712, and/or other applications 716, which may correspond to executable processes, procedures, and/or applications with associated hardware. For example, the user device 710 may receive a message from the server 730 and display the message via the UI application 712. In other embodiments, user device 710 may include additional or different modules having specialized hardware and/or software as required.

In one embodiment, UI application 712 may communicatively and interactively generate a UI for an AI agent implemented through the neural network module 530 (e.g., an LLM agent) at server 730. In at least one embodiment, a user operating user device 710 may enter a user utterance, e.g., via text or audio input, such as a question, uploading a document, and/or the like via the UI application 712. Such user utterance may be sent to server 730, at which the neural network module 530 may perform cache pruning via the process described in FIGS. 3 and 4A-4B. The neural network module 530 may cause a display of cache pruning metrics at UI application 712 and interactively update the display in real time with the user utterance.

In various embodiments, user device 710 includes other applications 716 as may be desired in particular embodiments to provide features to user device 710. For example, other applications 716 may include security applications for implementing client-side security features, programmatic client applications for interfacing with appropriate application programming interfaces (APIs) over network 760, or other types of applications. Other applications 716 may also include communication applications, such as email, texting, voice, social networking, and IM applications that allow a user to send and receive emails, calls, texts, and other notifications through network 760. For example, the other application 716 may be an email or instant messaging application that receives a prediction result message from the server 730. Other applications 716 may include device interfaces and other display modules that may receive input and/or output information. For example, other applications 716 may contain software programs for asset management, executable by a processor, including a graphical user interface (GUI) configured to provide an interface to the user 740 to view the cache pruning metrics.

User device 710 may further include database 718 stored in a transitory and/or non-transitory memory of user device 710, which may store various applications and data and be utilized during execution of various modules of user device 710. Database 718 may store user profile relating to the user 740, predictions previously viewed or saved by the user 740, historical data received from the server 730, and/or the like. In some embodiments, database 718 may be local to user device 710. However, in other embodiments, database 718 may be external to user device 710 and accessible by user device 710, including cloud storage systems and/or databases that are accessible over network 760.

User device 710 includes at least one network interface component 717 adapted to communicate with data vendor server 745 and/or the server 730. In various embodiments, network interface component 717 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 745 may correspond to a server that hosts database 719 to provide training datasets to the server 730. The database 719 may be implemented by one or more relational database, distributed databases, cloud databases, and/or the like.

The data vendor server 745 includes at least one network interface component 726 adapted to communicate with user device 710 and/or the server 730. In various embodiments, network interface component 726 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 745 may send asset information from the database 719, via the network interface 726, to the server 730.

The server 730 may be housed with the neural network module 530 and its submodules (e.g., KV cache module 531) described in FIG. 5. In some implementations, neural network module 530 may receive data from database 719 at the data vendor server 745 via the network 760 to generate output metrics. The generated metrics may also be sent to the user device 710 for review by the user 740 via the network 760.

The database 732 may be stored in a transitory and/or non-transitory memory of the server 730. In one implementation, the database 732 may store data obtained from the data vendor server 745. In one implementation, the database 732 may store parameters of the neural network module 530. In one implementation, the database 732 may store previously generated metrics, and the corresponding input feature vectors.

In some embodiments, database 732 may be local to the server 730. However, in other embodiments, database 732 may be external to the server 730 and accessible by the server 730, including cloud storage systems and/or databases that are accessible over network 760.

The server 730 includes at least one network interface component 733 adapted to communicate with user device 710 and/or data vendor servers 745, 770 or 780 over network 760. In various embodiments, network interface component 733 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 760 may be implemented as a single network or a combination of multiple networks. For example, in various embodiments, network 760 may include the Internet or one or more intranets, landline networks, wireless networks, and/or other appropriate types of networks. Thus, network 760 may correspond to small scale communication networks, such as a private or local area network, or a larger scale network, such as a wide area network or the Internet, accessible by the various components of system 700.

### Example Workflows

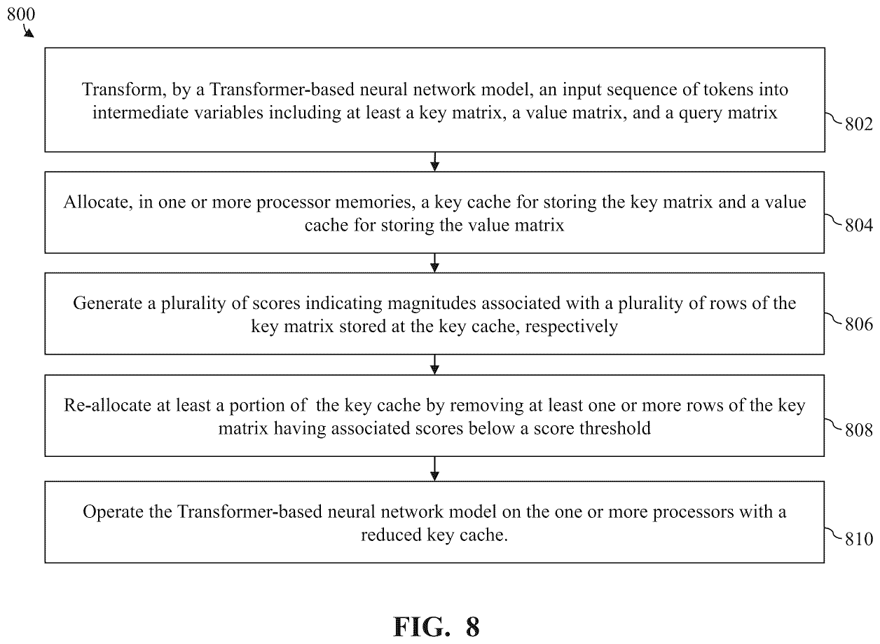

FIG. 8 is an example logic flow diagram illustrating a method 800 of managing cache usage on a graphic processing unit (GPU) for a Transformer-based neural network model implemented in FIGS. 3 and 4A-4B, along with the architecture 200 shown in FIG. 2, according to some embodiments described herein. One or more of the processes of method 800 may be implemented, at least in part, in the form of executable code stored on non-transitory, tangible, machine-readable media that when run by one or more processors may cause the one or more processors to perform one or more of the processes. In some embodiments, method 800 corresponds to the operation of the neural network module 530 and its submodules (e.g., KV Cache Module 531) that performs key cache and/or value cache pruning.

In some embodiments, method 800 is performed by a system such as computing device 500, user device 710, server 730, or another device or combination of devices. Inputs (e.g., embeddings, queries, values, and/or keys) may be received via a data interface such as data interface 515, network interface 717, network interface 733, or via a data interface that is integrated with a device. For example, UI Application 712 may receive user inputs via a text input interface (e.g., keyboard), audio input (e.g., microphone), video interface (e.g., camera), or other interface for receiving user inputs (e.g., a mouse or touch display).

As illustrated, the method 800 includes a number of enumerated steps, but aspects of the method 800 may include additional steps before, after, and in between the enumerated steps. In some aspects, one or more of the enumerated steps may be omitted or performed in a different order.

The method 800 manages cache usage on a graphic processing unit (GPU) (or other processors) by pruning KV cache. At step 802, the method transforms, by a Transformer-based neural network model (e.g., LLM 110 and/or architecture 200), an input sequence of tokens (e.g., embeddings 202) into intermediate variables including at least a key matrix, a value matrix, and a query matrix (e.g., the key matrix stores keys 302 and the query matrix stores queries 305). The Transformer-based neural network model may be implemented by one or more processors.

At step 804, the method allocates, in one or more processor memories, a key cache (e.g., key cache 450) for storing the key matrix and a value cache for storing the value matrix. The key cache and value cache may be collectively referred to as the KV cache.

At step 806, the method generates a plurality of scores (e.g., criterion scores 315) indicating magnitudes associated with a plurality of rows of the key matrix. Each row of the plurality of rows corresponds to a channel in the D dimension and is stored at the key cache. A separate score is associated with each row of the plurality of rows. The plurality of scores may be attention scores for query-driven pruning or absolute magnitude scores for magnitude-based pruning.

At step 808, the method re-allocates at least a portion of the key cache (e.g., key cache 450) by removing at least one or more rows of the key matrix having associated scores below a score threshold. For example, portions of the old keys 402 in the key cache 450 are pruned and removed, such as through a channel mask 303 and according to the framework 300 and architecture 400a. The result is a reduced key cache (e.g., pruned keys 304) having reduced channels in the D dimension for the key matrix.

At step 806, the method operates the Transformer-based neural network model (e.g., LLM 110 and/or architecture 200) on the one or more processors with a reduced key cache (e.g., pruned keys 304).

In one embodiment, method 800 for pruning KV cache of a Transformer-based LLM model may be performed periodically, intermittently, and/or on demand. For example, during training or inference, method 800 may be performed to prune KV cache based on the input tokens being processed while sequentially predicting a next token. For another example, method 800 may be performed periodically to reduce KV cache size, e.g., based on textual inputs (and the K, V matrices generated thereof) that are processed during a period of time. For another example, method 800 may be performed, in response to a cache management request or situation, e.g., when available cache space is low and/or processing speed is low due to limited cache size.

In one embodiment, Transformer-based LLM model with cache management described in method 800 may be used to build an AI agent similar to that in FIG. 1. Specifically, when input size to the AI agent grows and becomes long, the AI agent operated with method 800 may achieve hardware efficiency.

### Example Results

Evaluations of the methods/frameworks herein described (i.e., KV cache pruning and compression) were performed on two widely used benchmarks: LongBench and Needle-in-a-Haystack. Long-Bench, and the evaluations are designed to comprehensively evaluate LLM's long context understanding capabilities. The evaluation includes 17 datasets covering six different tasks: single-document QA, multi-document QA, summarization, few-shot learning, synthetic tasks, and code completion. The average input length of LongBench is 6,711 words, which necessitates reducing the KV cache to lower memory usage for inference. Needle-in-a-Haystack is a recent popular test challenge that requires models to accurately identify a small piece of information (“needle”) in a long document (“haystack”), where the needle is placed at a random position. This challenge can test if KV cache compression methods still retain the small piece of critical information.

The baseline methods include Heavy Hitter Oracle (H2O), SnapKV and KIVI, all of which are KV cache compression methods but use different strategies. H2O is designed to reduce memory usage by dynamically balancing recent tokens and Heavy Hitter (H2) tokens, where H2 tokens are a small set of tokens that contribute most of the value when computing attention scores. SnapKV automatically compresses KV caches by selecting clustered important KV positions for each attention head. KIVI quantizes the KV cache into low-precision to reduce the memory cost.

In one experiment, LLaMA-3-8B-Instruct and Mistral-7B-Instruct-v0.2 were used as the backbone LLMs, both accessible via HuggingFace. The goal is to prune channels of the KV, which is agnostic to KV cache compression methods (e.g., H2O, SnaoKV, etc.). If there is no other statement, the key cache is pruned by default. All the experiments are conducted using one NVIDIA A100. To fairly compare KV cache compression methods and KV cache compression integrated with the channel pruning method herein described (e.g., framework 300), the same hyperparameters were used for both. For example, when comparing SnapKV and SnapKV integrated with the pruning method pruning method herein described (e.g., framework 300), the maximum pooling is set to kernel size 7 and the observation window size to 32, using the same KV-size for both.

Tables 1 and 2 below present the results of (1) KV compression methods and (2) KV compression methods integrated with the key cache channel pruning method described herein (e.g., framework 300), over two different base LLMs across various KV-sizes on LongBench.

TABLE 1

| | Single-Document QA | | | Multi-Document QA | | | [symbol] | | |
|---|---|---|---|---|---|---|---|---|---|
| Method | [symbol] QA | [symbol] | [symbol] | [symbol] QA | [symbol] | [symbol] | [symbol] Report | [symbol] | [symbol] |

LLaMa-3 B8, KV-size

[symbol]

| | | | | | | | | | |
|---|---|---|---|---|---|---|---|---|---|
| ALL KV | 25.56 | 32.27 | [symbol] .71 | 4 [symbol] . [symbol] 6 | [symbol] .09 | 21.18 | 28.71 | 2 [symbol] .26 | 26. [symbol] 4 |

LLaMa-3 B8, KV-size 128

| | | | | | | | | | |
|---|---|---|---|---|---|---|---|---|---|
| H2O | 22.12 | 13.20 | 31.61 | [symbol] 7.79 | [symbol] 2.71 | 18.4 [symbol] | 20.32 | 22.02 | 21.1 [symbol] |
| +Think(0.4) | 22.8 [symbol] | 14.55 | 29.49 | 38.63 | 30.84 | 18.9 [symbol] | 20.12 | 21.96 | 20. [symbol] |
| +Think(0.5) | 2 [symbol] .47 | 14.06 | 28.67 | 38.35 | 30.21 | 17.87 | 19.69 | 21.94 | 19.95 |
| SnapKV | 21.19 | 13. [symbol] | 32. [symbol] | 38.75 | 29.64 | 18.7 [symbol] | 18. [symbol] 8 | 21. [symbol] 2 | [symbol] .2 [symbol] |
| +Think(0.4) | 21.11 | 14.67 | 32.49 | 36.25 | 2 [symbol] .63 | 1 [symbol] .80 | 18. [symbol] 3 | 21.4 [symbol] | 20.14 |
| +Think(0.5) | 21.7 [symbol] | 14.73 | 12.03 | 37.52 | 27.86 | 18.28 | 18.50 | 21.52 | 19.71 |

LLaMa-3 B8, KV-size 512

| | | | | | | | | | |
|---|---|---|---|---|---|---|---|---|---|
| H2O | 23.52 | 17. [symbol] 3 | 34. [symbol] 8 | 42.11 | 33.52 | 19. [symbol] 2 | 22.11 | 22. [symbol] | 23.82 |
| +Think(0.4) | 23.76 | 17.80 | [symbol] .80 | 40.19 | 3 [symbol] .7 [symbol] | 19.0 [symbol] | 21.82 | 22.51 | 23.75 |
| +Think(0.5) | 24.17 | 16.96 | [symbol] 5.76 | [symbol] .47 | 3 [symbol] .29 | 18.67 | 21. [symbol] 9 | 22. [symbol] 9 | 2 [symbol] .03 |
| +Think(0.6) | 23.40 | 14.83 | [symbol] 2.62 | [symbol] 8.47 | 30.97 | 19.81 | 20.80 | 22.04 | 21. [symbol] |
| SnapKV | 24.84 | 2 [symbol] . [symbol] | 38.77 | 42.75 | 34.55 | 20.87 | 22.26 | 22.61 | 23.97 |
| +Think(0.4) | 24.58 | 25.44 | 37.03 | 41. [symbol] 7 | 33.45 | 20.58 | 21.77 | 22.42 | 24.1 [symbol] |
| +Think(0.5) | 24.85 | 25.10 | 37.0 [symbol] | 41.58 | 32. [symbol] | 20. [symbol] | 21.61 | 22.44 | 23.66 |
| +Think(0.6) | 25.98 | 22.77 | [symbol] 8.37 | 40.44 | 3 [symbol] .1 [symbol] | 1 [symbol] . [symbol] | 20.84 | 22.21 | 22.55 |

LLaMa-3 B8, KV-size 1024

| | | | | | | | | | |
|---|---|---|---|---|---|---|---|---|---|
| H2O | 25.62 | 22.16 | 36.81 | 41.01 | 33.53 | 19.41 | 2 [symbol] .28 | 22.65 | 25.41 |
| +Think(0.4) | 2 [symbol] . [symbol] 2 | 21. [symbol] 3 | 37.17 | 41.56 | 31.22 | 20.17 | 22.89 | 22. [symbol] | 25.21 |
| +Think(0.5) | 25.41 | 22.19 | 37.64 | 40.92 | 31.27 | 18.66 | 22.17 | 22.22 | 24.8 [symbol] |
| +Think(0.6) | 24.0 [symbol] | 17.80 | 37.85 | [symbol] 8. [symbol] 3 | 2 [symbol] .98 | 19.40 | 21.41 | 22.32 | 2 [symbol] .42 |
| SnapKV | 24. [symbol] 2 | [symbol] 5.99 | 37.64 | 4 [symbol] .84 | 34.99 | 20. [symbol] | 24.28 | 22. [symbol] | [symbol] . [symbol] |
| +Think(0.4) | 24.88 | 27.72 | 28. [symbol] | 43..16 | 32.44 | 20. [symbol] 7 | 24.21 | 22.79 | 25. [symbol] |
| +Think(0.5) | 24.82 | 27.2 [symbol] | 3 [symbol] . [symbol] | 42. [symbol] 2 | 32.09 | 19. [symbol] | 2 [symbol] . [symbol] 2 | 22.48 | 25.34 |
| +Think(0.6) | 24.46 | 27.35 | [symbol] 8.22 | 41. [symbol] | 31.64 | 20.18 | 21.89 | 22.83 | 2 [symbol] . [symbol] |

LLaMa-3 B8, KV-size 2048

| | | | | | | | | | |
|---|---|---|---|---|---|---|---|---|---|
| H2O | 25.56 | 26.85 | 39.54 | 44. [symbol] 0 | 32. [symbol] 2 | 21.0 [symbol] | 24.68 | 23. [symbol] | 26.16 |
| +Think(0.4) | 25.56 | 2 [symbol] .31 | [symbol] .2 [symbol] | 42.96 | 31.81 | 20.53 | 24.23 | 23. [symbol] | 25.90 |
| +Think(0.5) | 25.01 | 25.37 | [symbol] 8.82 | 42.12 | 31.27 | 20.5 [symbol] | 21.78 | 2 [symbol] .21 | 26.06 |
| +Think(0.6) | 24. [symbol] 7 | 22.14 | 37.77 | 4 [symbol] .13 | 2 [symbol] .5 [symbol] | 20.26 | 22.09 | 22.76 | 24.78 |
| SnapKV | 2 [symbol] .86 | 29. [symbol] | 41.10 | 44. [symbol] | 35. [symbol] | 21.81 | 25. [symbol] 8 | 23.40 | 26. [symbol] |
| +Think(0.4) | 25.41 | 29.79 | 39.21 | 43. [symbol] 5 | 33. [symbol] | 21.4 [symbol] | 25.78 | 23.11 | 26.1 [symbol] |
| +Think(0.5) | 25. [symbol] | [symbol] .25 | [symbol] .27 | 43.23 | 32. [symbol] 3 | 21.24 | 25.16 | 23.01 | 26. [symbol] |
| +Think(0.6) | 24. [symbol] | 28.88 | 40.44 | 41. [symbol] 0 | 29. [symbol] | 21.34 | 2 [symbol] .48 | 22. [symbol] | 24. [symbol] |

LLaMa-3 70B, KV-size 128

| | | | | | | | | | |
|---|---|---|---|---|---|---|---|---|---|
| SnapKV | 25.91 | 3 [symbol] .41 | 4 [symbol] .83 | 49.6 [symbol] | 21.2 [symbol] | 27.7 [symbol] | 22.14 | 21. [symbol] | 23.1 [symbol] |
| +Think(0.4) | 25. [symbol] | 39.20 | 43.60 | 50.22 | 50. [symbol] | 29.32 | 21.70 | 21. [symbol] | 2 [symbol] .35 |
| +Think(0.5) | 26. [symbol] 1 | 38.7 [symbol] | 44.86 | 48.54 | 4 [symbol] . [symbol] 2 | 28.97 | 21.46 | 22.01 | 22.01 |

LLaMa-3 70B, KV-size 512

| | | | | | | | | | |
|---|---|---|---|---|---|---|---|---|---|
| SnapKV | 27.95 | 4 [symbol] .1 [symbol] | 48.5 [symbol] | 50.97 | [symbol] . [symbol] 3 | 29.78 | 25. [symbol] 4 | 22. [symbol] 6 | 26.03 |
| +Think(0.4) | 27.47 | 45.32 | 48.57 | 51.22 | 54.32 | [symbol] 0.0 [symbol] | 2 [symbol] .42 | 22.72 | 26.2 [symbol] |
| +Think(0.5) | 26. [symbol] 7 | 44.55 | 48.16 | 50.84 | 53.80 | 30.57 | 25.29 | 22. [symbol] | 25.53 |

LLaMa-3 70B, KV-size 1024

| | | | | | | | | | |
|---|---|---|---|---|---|---|---|---|---|
| SnapKV | 26.80 | 46.21 | 49.93 | 51.70 | 54.71 | 29.86 | 27.61 | 22.43 | 27.15 |
| +Think(0.4) | 27.04 | 46.01 | 50.13 | 51.96 | 54.36 | 29.87 | 27.74 | 22.78 | 27. [symbol] 7 |
| +Think(0.5) | 27.62 | 46.22 | 48.97 | 51.79 | 53.39 | 30.47 | 27.45 | 2 [symbol] .05 | 26. [symbol] 7 |

LLaMa-3 70B, KV-size 2048

| | | | | | | | | | |
|---|---|---|---|---|---|---|---|---|---|
| SnapKV | 27.44 | 46.51 | 49.60 | 51.80 | 54.77 | 31.0 [symbol] | 2 [symbol] .67 | 22.44 | 27.43 |
| +Think(0.4) | 27.13 | 46.26 | [symbol] .04 | 51.72 | 55.03 | 31.19 | 2 [symbol] .75 | 22.47 | 27.28 |
| +Think(0.5) | 27.84 | 46.86 | 49.18 | 51.97 | 53.58 | 31.44 | 29.41 | 22. [symbol] | 27. [symbol] |

| | [symbol] - [symbol] learning | | | [symbol] | | [symbol] | | |
|---|---|---|---|---|---|---|---|---|
| Method | [symbol] | [symbol] QA | SAM [symbol] | PCount | PR [symbol] | Lcc | RB-P | Avg. |
| LLaMa-3 B8, KV-size [symbol] | | | | | | | | |
| ALL KV | 73.5 [symbol] | [symbol] 0.48 | 42.33 | 4.80 | 69.25 | 5 [symbol] .29 | 54.05 | 41.86 |
| LLaMa-3 B8, KV-size 128 | | | | | | | | |
| H2O | 38.50 | 87.75 | [symbol] .14 | 5.83 | 6 [symbol] .50 | 55.06 | 50. [symbol] 7 | [symbol] .0 [symbol] |
| +Think(0.4) | 38.50 | 86.38 | 38.40 | 5.50 | 68.17 | 57.93 | 56.12 | 35.63 |
| +Think(0.5) | 3 [symbol] .50 | 57.14 | 38.87 | 4. [symbol] 2 | 69.5 [symbol] | 57.99 | 5 [symbol] .66 | 35.44 |
| SnapKV | 45. [symbol] | 88. [symbol] | 37. [symbol] | 5.13 | 68.8 [symbol] | 55.8 [symbol] | 51.82 | 35.50 |
| +Think(0.4) | 44. [symbol] | 88.11 | 38. [symbol] 2 | 5.75 | 69.17 | 58. [symbol] 1 | 55.89 | 35.84 |
| +Think(0.5) | 43.50 | 86.00 | 38.35 | 5.59 | 69.50 | 57.96 | 56.96 | [symbol] 5.61 |
| LLaMa-3 B8, KV-size 512 | | | | | | | | |
| H2O | 41.00 | [symbol] .46 | 4 [symbol] .2 [symbol] | 5.87 | 69. [symbol] | 56.71 | 51.69 | 37.23 |
| +Think(0.4) | 41.00 | 90.16 | 4 [symbol] .67 | 5.15 | 69.25 | [symbol] .77 | 57. [symbol] 8 | 37.39 |
| +Think(0.5) | 41.00 | 89.81 | 4 [symbol] .15 | 5.23 | 69.33 | 60.2 [symbol] | 58.34 | 37.29 |
| +Think(0.6) | 40.0 [symbol] | [symbol] .79 | [symbol] . [symbol] | 5.36 | 68.5 [symbol] | 58.28 | 57.65 | [symbol] 6.44 |
| SnapKV | 70.00 | 90. [symbol] 2 | 40.29 | 5.81 | 69. [symbol] 0 | [symbol] .04 | 51381 | 40.10 |
| +Think(0.4) | 70.00 | [symbol] . [symbol] | 4 [symbol] .29 | 6.06 | 69.5 [symbol] | 62.05 | 59.23 | 40.55 |
| +Think(0.5) | [symbol] . [symbol] 0 | [symbol] . [symbol] | 39.70 | 5.84 | 69.79 | 61.57 | 59.42 | 40.34 |
| +Think(0.6) | 5 [symbol] .00 | 90. [symbol] 2 | 38.12 | 6.39 | 69.5 [symbol] | 59.14 | 58.40 | 39.20 |
| LLaMa-3 B8, KV-size 1024 | | | | | | | | |
| H2O | 4 [symbol] . [symbol] | [symbol] . [symbol] 2 | 41.78 | 5.79 | 69.2 [symbol] 5 | [symbol] . [symbol] | [symbol] .50 | 38.70 |
| +Think(0.4) | 47.00 | 9 [symbol] .74 | 41.34 | 5.57 | 69.50 | 62.58 | 58.67 | 39.00 |
| +Think(0.5) | 56.40 | 90.34 | 40.59 | 5.20 | 69.5 [symbol] | 61.71 | 57.99 | 38.57 |
| +Think(0.6) | 44.50 | 90.16 | 39.43 | 5.84 | 69.5 [symbol] | 58.31 | 58.73 | 37.58 |
| SnapKV | [symbol] . [symbol] | 90. [symbol] | 40.41 | 5.36 | 69.2 [symbol] | 6 [symbol] . [symbol] 7 | [symbol] .11 | 40.88 |
| +Think(0.4) | 71. [symbol] 0 | [symbol] 0.4 [symbol] | 70. [symbol] 4 | 5.93 | 69. [symbol] 0 | 62.77 | 5 [symbol] .45 | 41.29 |
| +Think(0.5) | 71. [symbol] 0 | 90.4 [symbol] | 4 [symbol] .74 | 5.20 | 69.5 [symbol] | 62.4 [symbol] | 59.75 | 41.07 |
| +Think(0.6) | 70.00 | 90.19 | 38.69 | 6.10 | 69.50 | 58.87 | 5 [symbol] .26 | 40.30 |
| LLaMa-3 B8, KV-size 2048 | | | | | | | | |
| H2O | 53.00 | 90.6 [symbol] | 41.84 | 4.91 | 69.25 | 58.43 | 51.31 | 39.59 |
| +Think(0.4) | 53.50 | 90.56 | 41.03 | 5.52 | 69.25 | 62.10 | 59.00 | 40.05 |
| +Think(0.5) | 53.0 [symbol] | 90. [symbol] 7 | 4 [symbol] .86 | 5.13 | 69.50 | 61.91 | 58.95 | 39.75 |
| +Think(0.6) | 49.50 | 90.16 | [symbol] 9.69 | 5.56 | 69.50 | 29.24 | 58.78 | 38.51 |
| SnapKV | 7 [symbol] . [symbol] | 90. [symbol] 6 | 41.66 | 5.17 | 69.2 [symbol] | 58. [symbol] 7 | 51.52 | 41.58 |
| +Think(0.4) | 7 [symbol] .00 | 90. [symbol] 6 | 41.79 | 5.81 | 69. [symbol] 0 | 62.45 | 59.1 [symbol] | 41.91 |
| +Think(0.5) | 73.00 | 90.37 | 41.2 [symbol] | 5.45 | 69.5 [symbol] | 62.3 | 59.84 | 41.77 |
| +Think(0.6) | 72.50 | 90. [symbol] | 38.5 | 5.71 | 69.50 | 59.77 | 59. [symbol] | 40.88 |
| LLaMa-3 70B, KV-size 128 | | | | | | | | |
| SnapKV | [symbol] .00 | 91. [symbol] 5 | 43.54 | 12.50 | 72.00 | 4 [symbol] .41 | 63.49 | 44.89 |
| +Think(0.4) | 68.00 | 91.27 | 43.24 | 12.50 | 7 [symbol] .00 | 48.01 | [symbol] 2.43 | 44.00 |
| +Think(0.5) | [symbol] 7.00 | 91.52 | 43.15 | 12.50 | 72.50 | 47.21 | 603.82 | 43.63 |
| LLaMa-3 70B, KV-size 512 | | | | | | | | |
| SnapKV | 73.50 | 92. [symbol] 3 | 45.07 | 12.50 | 72.50 | 45.21 | 68.22 | 46.27 |
| +Think(0.4) | 73.50 | 91.13 | 45.53 | 12.50 | 73.00 | 48.32 | [symbol] .99 | 46.45 |
| +Think(0.5) | 73.0 [symbol] | 92.13 | 43.66 | 12.50 | 73.00 | 50.52 | 64.82 | 46.12 |
| LLaMa-3 70B, KV-size 1024 | | | | | | | | |
| SnapKV | 73.50 | 92.38 | 4 [symbol] .18 | 12.50 | 72.50 | 42.84 | 69.89 | 46.64 |
| +Think(0.4) | 73.50 | 91.88 | 4 [symbol] .35 | 12.50 | 73.00 | 45.05 | 67.87 | 46.69 |
| +Think(0.5) | 73.5 [symbol] | 91.88 | 43.99 | 12.50 | 72.50 | 47.41 | 66.84 | 46.51 |
| LLaMa-3 70B, KV-size 2048 | | | | | | | | |
| SnapKV | 73.50 | 92.38 | 45.98 | 12.50 | 72.50 | 41.86 | 68.72 | 46.76 |
| +Think(0.4) | 73.50 | 91.88 | 4 [symbol] .37 | 12.50 | 72.5 [symbol] | 42.66 | 67.77 | 46.75 |
| +Think(0.5) | 73.50 | 91.88 | 43. [symbol] | 12.50 | 72.5 [symbol] | 44.78 | 66. [symbol] | 46.62 |

[symbol]

indicates data missing or illegible when filed

TABLE 2

| | Single-Document QA | | | Muli-Document QA | | | Summarization | | |
|---|---|---|---|---|---|---|---|---|---|
| Method | [symbol] QA | [symbol] | [symbol] | [symbol] QA | [symbol] QA | [symbol] | [symbol] Report | QM [symbol] | [symbol] News |

KV-size

[symbol]

| | | | | | | | | | |
|---|---|---|---|---|---|---|---|---|---|
| ALL KV | 26.63 | 32.99 | 49.34 | 42.77 | 27.35 | 18.77 | 32.87 | 24.24 | 27.10 |

KV-size 128

| | | | | | | | | | |
|---|---|---|---|---|---|---|---|---|---|
| H2O | 21.21 | 21.81 | 33.87 | 30.42 | 20.36 | 12.30 | 20.58 | 22.61 | 22.10 |
| +Think(0.4) | 21.17 | 21.90 | 39.29 | 29.92 | 20.99 | 12.30 | 20.84 | 22.91 | 21.92 |
| +Think(0.5) | 21.67 | 21.80 | 30.48 | 28.74 | 20.65 | 13.34 | 20.57 | 22.83 | 21.78 |
| +Think(06) | 21.04 | 21.30 | 39.56 | 28.68 | 21.29 | 13.97 | 20.13 | 22.52 | 21.81 |
| SnapKV | 19.17 | 21.40 | 42.93 | 36.76 | 22.44 | 15.8 [symbol] | 19.16 | 21.84 | 21.55 |
| +Think(0.4) | 20.52 | 21.00 | 42.65 | 37.58 | 22.03 | 15.23 | 19.29 | 22.01 | 21.22 |
| +Think(0.5) | 20.67 | 20.60 | 43.37 | 37.27 | 21.58 | 15.66 | 19.06 | 21.79 | 21.02 |
| +Think(0.6) | 21.25 | 20.82 | 44.20 | 36.21 | 21.68 | 16.47 | 19.05 | 21.99 | 20.73 |

KV-size 512

| | | | | | | | | | |
|---|---|---|---|---|---|---|---|---|---|
| H2O | 21.83 | 26.00 | 44.69 | 32.46 | 23.05 | 14.69 | 23.53 | 23.06 | 24.5 [symbol] |
| +Think(0. 4) | 21.58 | 26.15 | 44.4 [symbol] | 32.73 | 23.99 | 15.09 | 23.56 | 23.28 | 24.45 |
| +ThinK(0.5) | 22.76 | 25.74 | 44.61 | 31.74 | 23.25 | 13.91 | 23.31 | 23.13 | 24.34 |
| +Think(0.6) | 22.91 | 23.57 | 44.04 | 29.48 | 22.88 | 13.67 | 23.31 | 22.64 | 24.10 |
| SnapKVT | 24.44 | 27.81 | 48.98 | 39.46 | 25.25 | 16.98 | 23.70 | 22.96 | 24.37 |
| +Think(0.4) | 24.27 | 28.46 | 49.26 | 38.13 | 24.22 | 16.92 | 23.59 | 23.70 | 24.46 |
| +Think(0.5) | 24.56 | 29.22 | 48.59 | 37.70 | 24.27 | 17.39 | 23.68 | 23.65 | 24.58 |
| +Think(0.6) | 24.07 | 28.27 | 49.10 | 38.65 | 24.31 | 17.52 | 23.16 | 23.51 | 24.23 |

KV-size 1024

| | | | | | | | | | |
|---|---|---|---|---|---|---|---|---|---|
| H2O | 23.67 | 28.55 | 46.40 | 36.99 | 24.82 | 15.02 | 25.21 | 23.04 | 25.77 |
| +ThinK(0.4) | 23.97 | 28.91 | 45.84 | 35.78 | 24.88 | 14.55 | 25.11 | 23.35 | 25.83 |
| +ThinK(0.5) | 23.89 | 28.40 | 46.60 | 35.57 | 24.26 | 14.78 | 24.98 | 23.31 | 25.68 |
| +Think(0.6) | 23.87 | 27.76 | 46.25 | 35.28 | 24.38 | 14.74 | 24.35 | 23.35 | 2 [symbol] .50 |
| SnapKV | 25.47 | 29.57 | 49.33 | 40.90 | 25.53 | 19.01 | 25.94 | 23.89 | 26.21 |
| +Think(0.4) | 25.22 | 30.48 | 48.58 | 41.11 | 25.28 | 18.99 | 25.91 | 24.00 | 26.13 |
| +Think(0.5) | 25.63 | 30.08 | 49.41 | 40.59 | 25.13 | 19.58 | 25.47 | 24.23 | 25.92 |
| +ThinK(0.6) | 24.69 | 29.3 | 48.90 | 40.44 | 25.33 | 19.58 | 25.23 | 23.6 | 25.25 |

KV-size 2048

| | | | | | | | | | |
|---|---|---|---|---|---|---|---|---|---|
| H2O | 25.76 | 31.10 | 49.06 | 40.38 | 26.43 | 16.78 | 27.17 | 23.64 | 26.69 |
| +ThinK(0.4) | 25.40 | 30.8 [symbol] | 48.45 | 39.64 | 26.08 | 16.82 | 27.12 | 23.79 | 26.65 |
| +ThinK(0.5) | 25.68 | 31.24 | 48.69 | 39.65 | 25.84 | 16.72 | 26.69 | 23.57 | 26.78 |
| +Think(0.6) | 25.83 | 31.00 | 48.23 | 38.58 | 25.71 | 16.54 | 26.51 | 23.81 | 26.28 |
| SnapKV | 25.89 | 32.56 | 48.33 | 41.68 | 27.24 | 18. [symbol] | 28.90 | 24.47 | 26.63 |
| +Think(0.4) | 25.77 | 32.67 | 48.70 | 41.06 | 27.07 | 19.14 | 28.91 | 24.37 | 26.88 |
| +Think(0.5) | 26.44 | 32.94 | 49.02 | 40.86 | 26.84 | 19.49 | 28.46 | 24.51 | 26.72 |
| +ThinK(0.6) | 26.00 | 32.53 | 48.73 | 40.95 | 26.77 | 18.92 | 27.40 | 23.97 | 26.37 |

| | | |
|---|---|---|
| [symbol] - [symbol] Learning | Synthetic | Code |

| | | | | | | | | |
|---|---|---|---|---|---|---|---|---|
| Method | TREC | [symbol] QA | SAMA [symbol] | PCourt | PC [symbol] | Lcc | RB-P | Avg. |

KV-size

[symbol]

| | | | | | | | | |
|---|---|---|---|---|---|---|---|---|
| ALL KV | 71.00 | 86.23 | 42.96 | 2.75 | 86.98 | 56.93 | 54.49 | 42.71 |

KV-size 128

| | | | | | | | | |
|---|---|---|---|---|---|---|---|---|
| H2O | 39.00 | 82.37 | 40.44 | 2.90 | 79.56 | 51.22 | 48.38 | 34.63 |
| +Think(0.4) | 39.00 | 82.70 | 40.35 | 2.97 | 79.21 | 51.19 | 48.32 | 34.6 [symbol] |
| +Think(0.5) | 39.00 | 82.54 | 40.12 | 3.61 | 78.39 | 50.27 | 48.4 | 34. [symbol] 6 |
| +Think(06) | 39.50 | 82. [symbol] 5 | 39.14 | 4.16 | 74.23 | 49.83 | 47.67 | 34.18 |
| SnapKV | 47. [symbol] | 84.15 | 40.24 | 2.30 | 68.2 [symbol] | 52.31 | 48.80 | 35.29 |
| +Think(0.4) | 47.00 | 83.85 | 39.64 | 3.20 | 67.45 | 51.48 | 48.31 | 35.16 |
| +Think(0.5) | 47.00 | 83.38 | 39.77 | 3.65 | 67.06 | 50.80 | 48.35 | 35.06 |
| +Think(0.6) | 45.00 | 83.81 | 38.79 | 4.19 | 66.90 | 49.90 | 47.61 | 34.92 |

KV-size 512

| | | | | | | | | |
|---|---|---|---|---|---|---|---|---|
| H2O | 42.00 | 85.22 | 41.40 | 3.40 | 86.20 | 54.78 | 51.09 | 37.38 |
| +Think(0. 4) | 42.00 | 85.58 | 42.58 | 3.18 | 85.7 | 54.39 | 51.15 | 37.49 |
| +ThinK(0.5) | 41.00 | 85.39 | 41.85 | 2.82 | 84.36 | 54.69 | 50.88 | 37.11 |
| +Think(0.6) | 41.00 | 85.31 | 41.15 | 2.98 | 82.34 | 53.70 | 50.25 | 36.58 |
| SnapKVT | 67.00 | 85.88 | 41.26 | 2.78 | 86.56 | 56.46 | 53.41 | 40.46 |
| +Think(0.4) | 67.50 | 85.9 | 42.51 | 2.92 | 85.32 | 55.89 | 53.35 | 40.40 |
| +Think(0.5) | 67.50 | 86.05 | 42.01 | 3.07 | 86.30 | 56.4 [symbol] | 53.29 | 40.52 |
| +Think(0.6) | 67.00 | 86.33 | 40.78 | 3.69 | 83.74 | 54.94 | 52.23 | 40.10 |

KV-size 1024

| | | | | | | | | |
|---|---|---|---|---|---|---|---|---|
| H2O | 46. [symbol] | 85.93 | 41.98 | 3.24 | 86.57 | 56.40 | 52.75 | 38.90 |
| +ThinK(0.4) | 45.50 | 86.11 | 42.44 | 3.23 | 84.82 | 56.21 | 53.02 | 38.72 |
| +ThinK(0.5) | 44.50 | 86.16 | 42.72 | 3.38 | 83.20 | 55.88 | 52.63 | 38.50 |
| +Think(0.6) | 44.50 | 85.38 | 41.37 | 3.34 | 81.42 | 55.21 | 51.89 | 38.04 |
| SnapKV | 69.50 | 86.48 | 42.10 | 2.98 | 88.56 | 57.19 | 53.60 | 41.64 |
| +Think(0.4) | 70.00 | 86.64 | 41.35 | 2.98 | 86.3 | 56.71 | 54.19 | 41.62 |
| +Think(0.5) | 69.5 | 86.67 | 42.31 | 2.74 | 84.78 | 57.43 | 53.59 | 41.44 |
| +ThinK(0.6) | 69.00 | 86. [symbol] 5 | 40.86 | 3.19 | 83.70 | 56.3 | 53.30 | 40.97 |

KV-size 2048

| | | | | | | | | |
|---|---|---|---|---|---|---|---|---|
| H2O | 55.00 | 86.35 | 42.48 | 2.72 | 86.64 | 56.98 | 53.91 | 40.69 |
| +ThinK(0.4) | 53.50 | 86.39 | 43.03 | 3.29 | 86.39 | 56.61 | 53.60 | 40.47 |
| +ThinK(0.5) | 52.00 | 86.74 | 42.85 | 4.01 | 83.46 | 57.12 | 53.67 | 40.25 |
| +Think(0.6) | 50.50 | 86.57 | 42.05 | 3.36 | 82.49 | 56.04 | 52.67 | 39.76 |
| SnapKV | 70.00 | 86.27 | 42. [symbol] | 3.09 | 86.93 | 57.44 | 53.83 | 42.18 |
| +Think(0.4) | 70.00 | 86.37 | 42.75 | 3.61 | 87.38 | 57.21 | 54.44 | 42.27 |
| +Think(0.5) | 70.00 | 86.56 | 41.75 | 2.78 | 84.70 | 56.47 | 54.15 | 41.98 |
| +ThinK(0.6) | 70.00 | 86.45 | 41.12 | 3.31 | 82.24 | 56.01 | 53.53 | 41.52 |

[symbol]

indicates data missing or illegible when filed

The following observations can be drawn: (1) The key cache channel pruning can further prune the channels of the key cache after compressing the KV cache with H2O and SnapKV. For the base model LLaMA-3-8B, the key cache channel pruning reduces memory usage and slightly improves performance for both H2O and SnapKV. For the base model Mistral-7B, the key cache channel pruning reduces memory with only a slight drop in performance in some cases. (2) For larger base model LLaMA-3-70B, the key cache channel pruning can also achieve compatible or even better performance after pruning 40% channels of key cache compared with SnapKV baselines. (3) When the KV-size is increased from 128 to 2048, the performance of our channel pruning method improves. Notably, with a KV cache size of 2048 and a pruning ratio of 0.4, the key cache channel pruning can even outperform the LLaMA-3-8B with a full KV cache. The above observations indicate that the key cache channel pruning is agnostic to existing KV cache compression methods and can further improve their performance and memory reduction. Additionally, the key cache channel pruning is more effective than 1_1 or 1_2 norm for magnitude-based channel pruning in LLMs.

Effectiveness of the key cache channel pruning is further validated by integrating it with the KV cache quantization technique KIVI, as demonstrated in Table 3 below. Initially, 40% of the key cache channels are pruned, followed by quantization of the remaining channels into 2-bit. Compared to the standard KIVI approach, the key cache channel pruning method achieves a 20% reduction in KV cache memory with negligible performance degradation.

TABLE 3

| | | Single-Document QA | | | Multi-Document QA | | | Summarization | | |
|---|---|---|---|---|---|---|---|---|---|---|
| Method | Bit | [symbol] QA | [symbol] | [symbol] | [symbol] QA | [symbol] | [symbol] | [symbol] Report | Qm [symbol] | [symbol] News |
| KIVI | 2 | 19.47 | 18. [symbol] 2 | 30.28 | 29.42 | 25.00 | 10.30 | 21.34 | 20.51 | 25.10 |
| +Think(0.4) | 2 | 19.46 | 19.01 | 30.52 | 28.79 | 25.78 | 9.53 | 22.11 | 20.66 | 25.73 |

| | [symbol] - [symbol] Learning | | | Synthetic | | Code | | |
|---|---|---|---|---|---|---|---|---|
| Method | TREC | [symbol] QA | SAMS [symbol] | PCount | PR [symbol] | Lcc | RB-P | Avg. |
| KIVI | 63.00 | 85.04 | 40.16 | 4.00 | 8.00 | 58.04 | 52.48 | 31.92 |
| +Think(0.4) | 63.00 | 84.62 | 41.54 | 3.50 | 7.00 | 56.51 | 48.92 | 31.77 |

[symbol]

indicates data missing or illegible when filed

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of managing cache usage on a graphic processing unit (GPU) for a Transformer-based neural network model, the method comprising:
transforming, by the Transformer-based neural network model implemented on one or more processors, an input sequence of tokens into intermediate variables including at least a key matrix, a value matrix, and a query matrix;
allocating, in one or more processor memories, a key cache for storing the key matrix and a value cache for storing the value matrix;
generating a plurality of scores indicating magnitudes associated with a plurality of rows of the key matrix stored at the key cache, respectively;
re-allocating at least a portion of the key cache by removing at least one or more rows of the key matrix having associated scores below a score threshold, each row of the key matrix corresponding to a channel of the key cache; and
operating the Transformer-based neural network model on the one or more processors with a reduced key cache after the re-allocating.

2. The method of claim 1, wherein the scores associated with each row in the key cache are attention scores computed using queries and keys in the respective query matrix and key matrix, wherein the re-allocating of the key cache filters the key matrix by only keeping rows in the key matrix that have attention scores higher than an attention score threshold.

3. The method of claim 2, wherein the key matrix is filtered through a channel mask matrix also stored in the key cache.

4. The method of claim 2, wherein the re-allocating further includes performing low-rank approximation on the key matrix based on the attention scores.

5. The method of claim 1, wherein the scores associated with each row in the key cache are absolute magnitude values of keys in the key matrix, wherein the re-allocating of the key cache filters the key matrix by only keeping channels in the rows that have magnitude values higher than a magnitude score threshold.

6. The method of claim 5, wherein the scores are first scores and the score threshold is a first score threshold, further comprising:
generating a plurality of second scores indicating magnitudes associated with a plurality of rows of the value matrix stored at the value cache, respectively;
re-allocating at least a portion of the value cache by removing at least one or more rows of the value matrix having associated second scores below a second score threshold, each row of the value matrix corresponding to a channel of the value cache; and
operating the Transformer-based neural network model on the one or more processors with a reduced value cache.

7. The method of claim 6, wherein the second scores associated with each row in the value cache are scores computed by multiplying respective values in the value matrix with attention scores calculated using queries and keys in the respective query matrix and key matrix, wherein the re-allocating of the value cache filters the value matrix by only keeping rows in the value matrix that have second scores higher than the second score threshold.

8. The method of claim 1,
wherein the key cache has a cache size defined by dimensions B×S×L×N×D, where B is a batch size of the input sequence, S is a sequence length of the input sequence, L is a total number of layer in the Transformer-based neural network model, N is a number of heads in each layer, and D is a total number of channels in each head,
wherein the removing of the at least one or more rows of the key matrix prunes one or more channels from the dimension D,
further comprising performing cache eviction and/or structured pruning techniques to prune the key cache from the dimension S or the dimension L.

9. A system for managing cache usage on a graphic processing unit (GPU) for a Transformer-based neural network model, the system comprising:
a memory that stores a Transformer-based neural network model and a plurality of processor-executable instructions;
a communication interface that receives an input sequence of tokens; and
one or more hardware processors that read and execute the plurality of processor-executable instructions from the memory to perform operations comprising:
transforming, by the Transformer-based neural network model, the input sequence of tokens into intermediate variables including at least a key matrix, a value matrix, and a query matrix;
allocating, in one or more processor memories, a key cache for storing the key matrix and a value cache for storing the value matrix;
generating a plurality of scores indicating magnitudes associated with a plurality of rows of the key matrix stored at the key cache, respectively;
re-allocating at least a portion of the key cache by removing at least one or more rows of the key matrix having associated scores below a score threshold, each row of the key matrix corresponding to a channel of the key cache; and
operating the Transformer-based neural network model on the one or more processors with a reduced key cache after the re-allocating.

10. The system of claim 9, wherein the scores associated with each row in the key cache are attention scores computed using queries and keys in the respective query matrix and key matrix, wherein the re-allocating of the key cache filters the key matrix by only keeping rows in the key matrix that have attention scores higher than an attention score threshold.

11. The system of claim 9, wherein the scores associated with each row in the key cache are absolute magnitude values of keys in the key matrix, wherein the re-allocating of the key cache filters the key matrix by only keeping channels in the rows that have magnitude values higher than a magnitude score threshold.

12. The system of claim 9, wherein the scores are first scores and the score threshold is a first score threshold, further comprising:
generating a plurality of second scores indicating magnitudes associated with a plurality of rows of the value matrix stored at the value cache, respectively;
re-allocating at least a portion of the value cache by removing at least one or more rows of the value matrix having associated second scores below a second score threshold, each row of the value matrix corresponding to a channel of the value cache; and
operating the Transformer-based neural network model on the one or more processors with a reduced value cache.

13. The system of claim 12, wherein the second scores associated with each row in the value cache are scores computed by multiplying respective values in the value matrix with attention scores calculated using queries and keys in the respective query matrix and key matrix, wherein the re-allocating of the value cache filters the value matrix by only keeping rows in the value matrix that have second scores higher than the second score threshold.

14. The system of claim 9,
wherein the key cache has a cache size defined by dimensions B×S×L×N×D, where B is a batch size of the input sequence, S is a sequence length of the input sequence, L is a total number of layer in the Transformer-based neural network model, N is a number of heads in each layer, and D is a total number of channels in each head,
wherein the removing of the at least one or more rows of the key matrix prunes one or more channels from the dimension D,
further comprising performing cache eviction and/or structured pruning techniques to prune the key cache from the dimension S or the dimension L.

15. A non-transitory machine-readable medium comprising a plurality of machine-executable instructions which, when executed by one or more processors, are adapted to cause the one or more processors to perform operations comprising:
transforming, by a Transformer-based neural network model, an input sequence of tokens into intermediate variables including at least a key matrix, a value matrix, and a query matrix;
allocating, in one or more processor memories, a key cache for storing the key matrix and a value cache for storing the value matrix;
generating a plurality of scores indicating magnitudes associated with a plurality of rows of the key matrix stored at the key cache, respectively;
re-allocating at least a portion of the key cache by removing at least one or more rows of the key matrix having associated scores below a score threshold, each row of the key matrix corresponding to a channel of the key cache; and
operating the Transformer-based neural network model with a reduced key cache after the re-allocating.

16. The medium of claim 15, wherein the scores associated with each row in the key cache are attention scores computed using queries and keys in the respective query matrix and key matrix, wherein the re-allocating of the key cache filters the key matrix by only keeping rows in the key matrix that have attention scores higher than an attention score threshold.

17. The medium of claim 16, wherein the key matrix is filtered through a channel mask matrix also stored in the key cache.

18. The medium of claim 16, wherein the re-allocating further includes performing low-rank approximation on the key matrix based on the attention scores.

19. The medium of claim 15, wherein the scores associated with each row in the key cache are absolute magnitude values of keys in the key matrix, wherein the re-allocating of the key cache filters the key matrix by only keeping channels in the rows that have magnitude values higher than a magnitude score threshold.

20. The medium of claim 15,
wherein the key cache has a cache size defined by dimensions B×S×L×N×D, where B is a batch size of the input sequence, S is a sequence length of the input sequence, L is a total number of layer in the Transformer-based neural network model, N is a number of heads in each layer, and D is a total number of channels in each head,
wherein the removing of the at least one or more rows of the key matrix prunes one or more channels from the dimension D,
further comprising performing cache eviction and/or structured pruning techniques to prune the key cache from the dimension S or the dimension L.
